(19) United States
(12) Patent Application Publication
(10) Pub. No.: US 2024/0005250 A1
(43) Pub. Date: Jan. 4, 2024

(54) DISTRIBUTED STORAGE AND CRYPTO-TOKEN MINING SYSTEMS AND METHODS

(71) Applicants: NOYAN BERKER, Istanbul (TR); SERDAR SERTTOP, Istanbul (TR)

(72) Inventors: NOYAN BERKER, Istanbul (TR); SERDAR SERTTOP, Istanbul (TR)

(21) Appl. No.: 18/144,148

(22) Filed: May 5, 2023

Related U.S. Application Data
(60) Provisional application No. 63/338,608, filed on May 5, 2022.
(60) Provisional application No. 63/394,965, filed on Aug. 3, 2022.

(51) Int. Cl. G06Q 10/0637

(52) U.S. Cl. CPC G06Q 10/06375

(57) ABSTRACT

A computer-implemented method comprising: managing a distributed decentralized cloud network by: using an advanced algorithms and crypto earnings and modeling tools to help DSPs estimate performance and earnings on prospective locations; providing superior insights by aggregating this information with an understanding of network traffic and hops; building a map of upstream bandwidth bottlenecks and low usage upstream pathways.

### CLAIM OF PRIORITY

This application claims priority to U.S. Provisional Application No. 63/338,608, filed on May 5, 2022, and titled DISTRIBUTED STORAGE AND CRYPTO-TOKEN MINING SYSTEMS AND METHODS. This provisional patent application is hereby incorporated by reference in its entirety.

### BACKGROUND

The increasing deployment of high-speed two-way networks to enterprise campuses, businesses, offices, homes, and other physical locations has driven the demand for hybrid and distributed cloud hosting and storage. There is an increased need for assessing and optimizing utilization of these resources not just on the capacity of the endpoint but on the aggregate upstream and downstream bandwidth.

The advent of blockchain has unlocked the potential for massively scaling these endpoints and abstracting the users of these services (e.g. customers) from those who provide the infrastructure (e.g. distributed service providers (DSP)). This has given rise to the need for service providers to understand how their bandwidth performs regardless of the endpoint. The arrival of cryptographic tokens associated with these services based on a “proof of hosting” or a “proof of storage” has heightened the need for DSPs to estimate bandwidth related performance and crypto earnings dependent on bandwidth.

### SUMMARY OF THE INVENTION

A computer-implemented method comprising: managing a distributed decentralized cloud network by: using an advanced algorithms and crypto earnings and modeling tools to help DSPs estimate performance and earnings on prospective locations; providing superior insights by aggregating this information with an understanding of network traffic and hops; building a map of upstream bandwidth bottlenecks and low usage upstream pathways.

### BRIEF DESCRIPTION OF THE DRAWINGS

FIG. 1 illustrates an example distributed decentralized cloud network, according to some embodiments.

FIG. 2 illustrates an example process for managing a distributed decentralized cloud network, according to some embodiments.

FIG. 3 depicts an exemplary computing system that can be configured to perform any one of the processes provided herein.

The Figures described above are a representative set and are not an exhaustive with respect to embodying the invention.

### DESCRIPTION

Disclosed are a system, method, and article of manufacture for distributed storage and crypto-token mining. The following description is presented to enable a person of ordinary skill in the art to make and use the various embodiments. Descriptions of specific devices, techniques, and applications are provided only as examples. Various modifications to the examples described herein can be readily apparent to those of ordinary skill in the art, and the general principles defined herein may be applied to other examples and applications without departing from the spirit and scope of the various embodiments.

Reference throughout this specification to ‘one embodiment,’ ‘an embodiment,’ ‘one example,’ or similar language means that a particular feature, structure, or characteristic described in connection with the embodiment is included in at least one embodiment, according to some embodiments. Thus, appearances of the phrases ‘in one embodiment,’ ‘in an embodiment,’ and similar language throughout this specification may, but do not necessarily, all refer to the same embodiment.

Furthermore, the described features, structures, or characteristics of the invention may be combined in any suitable manner in one or more embodiments. In the following description, numerous specific details are provided, such as examples of programming, software modules, user selections, network transactions, database queries, database structures, hardware modules, hardware circuits, hardware chips, etc., to provide a thorough understanding of embodiments of the invention. One skilled in the relevant art can recognize, however, that the invention may be practiced without one or more of the specific details, or with other methods, components, materials, and so forth. In other instances, well-known structures, materials, or operations are not shown or described in detail to avoid obscuring aspects of the invention.

The schematic flow chart diagrams included herein are generally set forth as logical flow chart diagrams. As such, the depicted order and labeled steps are indicative of one embodiment of the presented method. Other steps and methods may be conceived that are equivalent in function, logic, or effect to one or more steps, or portions thereof, of the illustrated method. Additionally, the format and symbols employed are provided to explain the logical steps of the method and are understood not to limit the scope of the method. Although various arrow types and line types may be employed in the flow chart diagrams, and they are understood not to limit the scope of the corresponding method. Indeed, some arrows or other connectors may be used to indicate only the logical flow of the method. For instance, an arrow may indicate a waiting or monitoring period of unspecified duration between enumerated steps of the depicted method. Additionally, the order in which a particular method occurs may or may not strictly adhere to the order of the corresponding steps shown.

### Definitions

Example definitions for some embodiments are now provided.

Blockchain is a growing list of records, called blocks, that are securely linked together using cryptography. Each block contains a cryptographic hash of the previous block, a timestamp, and transaction data (e.g. generally represented as a Merkle tree, where data nodes are represented by leaves). The timestamp proves that the transaction data existed when the block was published to get into its hash. As blocks each contain information about the block previous to it, they form a chain, with each additional block reinforcing the ones before it. Therefore, blockchains are resistant to modification of their data because once recorded, the data in any given block cannot be altered retroactively without altering all subsequent blocks.

Crypto token refers to a special virtual currency token and/or a method for denominating cryptocurrencies. Crypto tokens can be fungible and tradable assets and/or utilities that reside on their own blockchains.

Hotspot is a physical location where people may obtain Internet access, typically using Wi-Fi technology, via a wireless local-area network (WLAN) using a router connected to an Internet service provider.

LoRaWAN together define a Low Power, Wide Area (LPWA) networking protocol designed to wirelessly connect battery operated ‘things’ to the internet in regional, national, or global networks, and targets key Internet of things (IoT) requirements such as bi-directional communication, end-to-end security, mobility, and localization services. The low power, low bit rate, and IoT use distinguish this type of network from a wireless WAN that is designed to connect users or businesses, and carry more data, using more power. The LoRaWAN data rate ranges from 0.3 kbit/s to 50 kbit/s per channel.

Proof of space (PoS) is a type of consensus algorithm achieved by demonstrating one's legitimate interest in a service (such as sending an email) by allocating a non-trivial amount of memory or disk space to solve a challenge presented by the service provider.

Secure copy protocol (SCP) is a means of securely transferring computer files between a local host and a remote host or between two remote hosts.

Example Systems and Methods

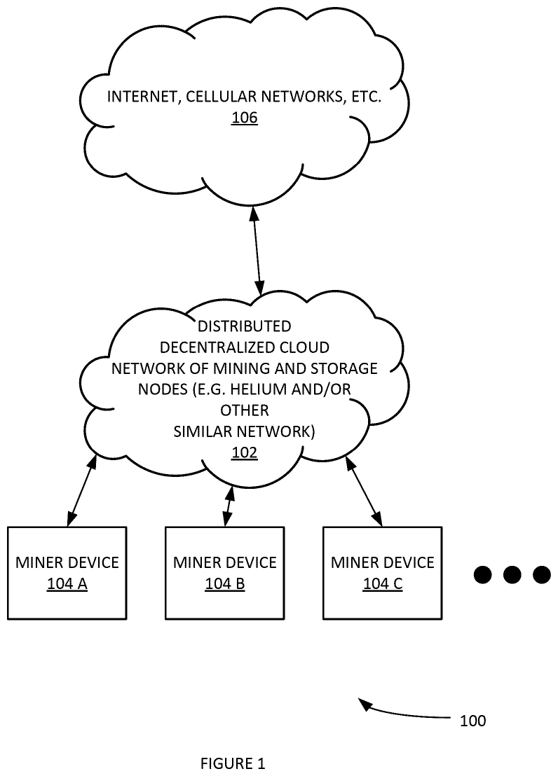

FIG. 1 illustrates an example distributed decentralized cloud network 100, according to some embodiments. Distributed decentralized cloud network of mining and storage nodes 102 can be a blockchain network that leverages a decentralized global network of hotspots. Miners 104 A-C can be devices that double as network miners and wireless access point. Miners 104 A-C can be used by distributed decentralized cloud network of mining and storage nodes 102 to provide long-range connectivity to Internet of Things (IoT) devices to connect other devises to the Internet 106 via a decentralized wireless network. Hotspots can be deployed by anyone with a miner 104 A-C. These users can earn/mine crypto tokens (e.g. Helium's native $HNT coins, etc.) in exchange for providing devices with connectivity.

Distributed decentralized cloud network of mining and storage nodes 102 can use decentralized, blockchain-based approach allows wireless infrastructure to scale more rapidly and at a fraction of the cost of traditional models. blockchain-based incentive model for operating a decentralized wireless network

Distributed decentralized cloud network of mining and storage nodes 102 can scale on an as-needed bases. The data is multi-region by default. Distributed decentralized cloud network of mining and storage nodes 102 can connect hard drives, SDR, etc. in a cloud-storage based in a blockchain. Distributed decentralized cloud network of mining and storage nodes 102 incentivize hosts to make miners 104 A-C available for storage (e.g. 5-10 terabyte). Helium provides incentives for proof of coverage.

Distributed decentralized cloud network of mining and storage nodes 102 can include various crypto-token miners in a distributed cloud with distributed storage. Distributed decentralized cloud network of mining and storage nodes 102 can add more services as a software to same hardware device to provide incentives for customers and this can decrease risk if value of a specific aspect of the network decreases. This can also minimize risk of users unplugging devices as they is a greater diversity of incentivization. In this way, node providers are incentivized to keep wireless network active regardless of Helium is doing.

Distributed decentralized cloud network of mining and storage nodes 102 can include a distributed infrastructure that provides hosting and storage. Distributed decentralized cloud network of mining and storage nodes 102 can be hybrid cloud storage (e.g. local and big storage). Distributed decentralized cloud network of mining and storage nodes 102 can create a blockchain so that infrastructure can be anonymous and trusted all over blockchain. Distributed decentralized cloud network of mining and storage nodes 102 can create a crypto token to pay those who provide hosting and storage services. Those who offer storage/hosting make money offering service and from value of token(s). Distributed decentralized cloud network of mining and storage nodes 102 manages software enabling multiple coin mining on a single hardware with wireless and various cloud services. Distributed decentralized cloud network of mining and storage nodes 102 can enable the estimating how much token coin with specific location that the device is in. It is noted that storage may depend on speed/type of network and storage earnings depend on this. It is noted that hosting may depend on coverage (e.g. first person in area or are there hundreds in a certain radius, etc.).

Miners 104 A-C can be a full hotspot for the (e.g. a Helium® Network, etc.) that seamlessly mounts right on a surface (e.g. a window) for enhanced coverage and improved performance with fast synchronization. Miners 104 A-C can include a high-performance processor and a resource optimized operating system. Miners 104 A-C delivers nearly non-stop mining effortlessly. Miners 104 A-C can work with LoRaWAN equipped devices that comply with LoRaWAN frequencies for the specified regions. Miners 104 A-C can be used to mine a plurality of crypto tokens. Miners 104 A-C can be affixed to smooth surfaces—the side of a bookshelf or a wall or even a windowpane.

Miners 104 A-C can include the following specifications, inter alia: Raspberry Pi 4RAM 4 GB or better; supported frequencies: RU864, IN865, AU915, KR920, AS923; Bluetooth 5, Wi-Fi 2.4 GHz, and 5 GHz; Ethernet Antenna; 2.6 dBi for US & Canada 2.8 dBi for UK and EU Antenna; etc. Miners 104 A-C can be setup with both iOS and Androidvia the Helium Application. Miners 104 A-C can provide a network for LoraBand that provides an incentive to users who host devices to provide the network. Miners 104 A-C can enable/be included in a distributed decentralized cloud network of mining and storage nodes 102.

In one example, a miner 104 A-C can be a FinestraMiner. FinestraMiner can be a member of the Mimiq Hub family and can be a combined crypto-currency miner and IoT gateway that upends the traditional economics of consumer electronics. With FinestraMiner, consumers can connect to the Helium Network and earn passive crypto income in Helium Network Token. By incorporating a reusable adhesive, FinestraMiner can be mounted on a window in seconds giving it improved mining performance. Hence a ‘miner with a view’. FinestraMiner can mines the Helium Network token ($HNT) and/or other types of crypto currencies/tokens and use the long-range LoRaWAN standard to connect compatible IoT devices—trackers, sensors, and gadgets—to the cloud. In one example, actual income can be subject to, among other factors, the rules of the Helium Network, actual install location, nearby miners, and price of the Helium Token none of which are set by Mimiq.

In some examples, miners 104 A-C can include hardware with an exposed SPC port exposed so it can connect a storage device (e.g. SSD storage, etc.) to a distributed network and also mine storage (e.g. on top of HNT and/or other coins like flexcoins, 3.0 coins, etc.). Miners 104 A-C can provide multiple incentives to hardware owners so that don't unplug if one HNT or other type of coin goes down.

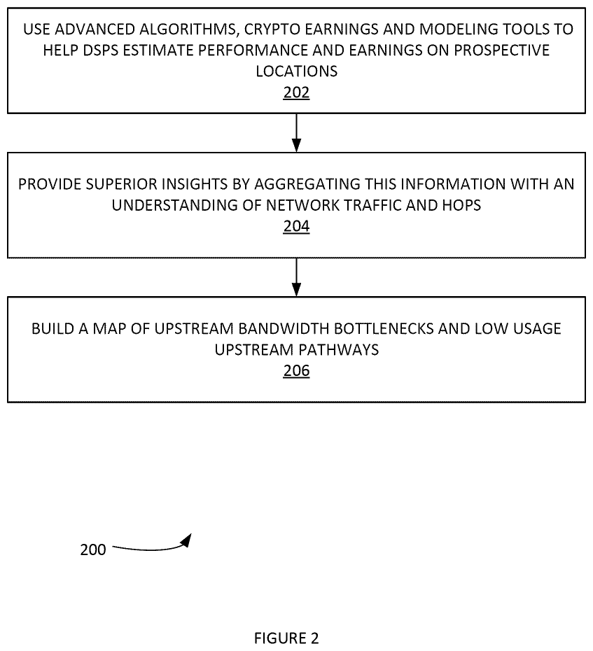

FIG. 2 illustrates an example process 200 for managing a distributed decentralized cloud network, according to some embodiments. In step 202, process 200 uses advanced algorithms and crypto earnings and modeling took to help DSPs estimate performance and earnings on prospective locations. In step 204, process 200 provides superior insights by aggregating this information with an understanding of network traffic and hops. In step 206, process 200 builds a map of upstream bandwidth bottlenecks and low usage upstream pathways.

Additional Example Computer Architecture and Systems

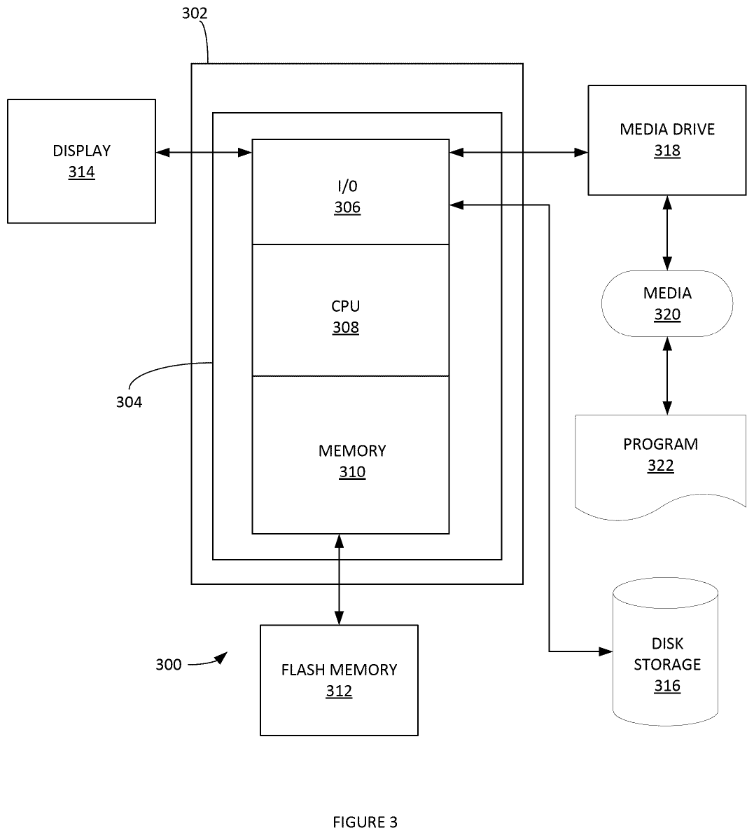

FIG. 3 depicts an exemplary computing system 300 that can be configured to perform any one of the processes provided herein. In this context, computing system 300 may include, for example, a processor, memory, storage, and I/O devices (e.g., monitor, keyboard, disk drive, Internet connection, etc.). However, computing system 300 may include circuitry or other specialized hardware for carrying out some or all aspects of the processes. In some operational settings, computing system 300 may be configured as a system that includes one or more units, each of which is configured to carry out some aspects of the processes either in software, hardware, or some combination thereof.

FIG. 3 depicts computing system 300 with a number of components that may be used to perform any of the processes described herein. The main system 302 includes a motherboard 304 having an I/O section 306, one or more central processing units (CPU) 308, and a memory section 310, which may have a flash memory card 312 related to it. The I/O section 306 can be connected to a display 314, a keyboard and/or other user input (not shown), a disk storage unit 316, and a media drive unit 318. The media drive unit 318 can read/write a computer-readable medium 320, which can contain programs 322 and/or data. Computing system 300 can include a web browser. Moreover, it is noted that computing system 300 can be configured to include additional systems in order to fulfill various functionalities. Computing system 300 can communicate with other computing devices based on various computer communication protocols such a Wi-Fi, Bluetooth® (and/or other standards for exchanging data over short distances includes those using short-wavelength radio transmissions), USB, Ethernet, cellular, an ultrasonic local area communication protocol, etc.

### CONCLUSION

Although the present embodiments have been described with reference to specific example embodiments, various modifications and changes can be made to these embodiments without departing from the broader spirit and scope of the various embodiments. For example, the various devices, modules, etc. described herein can be enabled and operated using hardware circuitry, firmware, software or any combination of hardware, firmware, and software (e.g., embodied in a machine-readable medium).

In addition, it can be appreciated that the various operations, processes, and methods disclosed herein can be embodied in a machine-readable medium and/or a machine accessible medium compatible with a data processing system (e.g., a computer system), and can be performed in any order (e.g., including using means for achieving the various operations). Accordingly, the specification and drawings are to be regarded in an illustrative rather than a restrictive sense. In some embodiments, the machine-readable medium can be a non-transitory form of machine-readable medium.

What is claimed by United States patent:

1. A computer-implemented method comprising:
managing a distributed decentralized cloud network by:
using an advanced algorithms and crypto earnings and modeling took to help DSPs estimate performance and earnings on prospective locations;
providing superior insights by aggregating this information with an understanding of network traffic and hops;
building a map of upstream bandwidth bottlenecks and low usage upstream pathways.
